(19) United States
(12) Patent Application Publication
(10) Pub. No.: US 2010/0017231 A1
(43) Pub. Date: Jan. 21, 2010

(54) Active Patient Management

(76) Inventors: Archie Galbraith, Iselin, NJ (US); Gaurav Garg, Iselin, NJ (US); Kanchan Ray, Greenwood City (IN); Justin Hai, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/505,290

(22) Filed: Jul. 17, 2009

Related U.S. Application Data
(60) Provisional application No. 61/081,510, filed on Jul. 17, 2008.

(51) Int. Cl. G06Q 50/00; G06F 3/048

(52) U.S. Cl. 705/3; 715/764

(57) ABSTRACT

A rules engine implemented on one or more processors can receive patient data from one or more hospital business application servers and update a transaction database stored on a memoir or storage device in communication with the one or more processors. The rules engine can execute a rule based on the patient data stored in transaction database and display content to a hospital staff member or a patient via a user interface based on the executed rule. The transaction database is updated by the rules engine upon receipt of a user response to the displayed content. Related systems, apparatus, methods, and/or articles are also described.

### CROSS-REFERENCE TO RELATED APPLICATIONS

This application claims the benefit of U.S. provisional patent application Ser. No. 61/081,510, filed on Jul. 17, 2008 and entitled “Active Patient Management,” which is incorporated by reference herein in its entirety.

### TECHNICAL FIELD

The subject matter described herein relates to management of patient care, for example in a health care setting.

### BACKGROUND

Many hospitals, nursing homes, clinics, doctors offices, and other health care provider facilities rely on multiple different technologies to handle a variety of tasks related to patient care, data management, and administration. For example, a hospital might have clinical systems that include a hospital admit/discharge/transfer (ADT) system that is responsible for centralizing admissions, discharges and transfers in a hospital; a laboratory information system (LIS), a cardiology information system (CIS), such as for example the MUSE electrocardiograph system available from GE Healthcare, a decision support system (DSS), and the like. Each of these systems handles an aspect of patient care, administration, education, or the like. Often, the various systems each have their own operating systems or interfaces and use of many of such systems can be quite cumbersome.

### SUMMARY

In one aspect of the currently disclosed subject matter, a computer-implemented includes updating a patient information database accessible to a rules engine that is implemented on the one or more processors. The updating occurs upon receipt of patient data from one or more hospital business application servers. The method also includes mapping a relevant educational video to a specific patient and members of the specific patient's primary care team to the specific patient based on the received patient data. The mapping is performed by the rules engine and is stored in a transaction database accessible to the rules engine. The rules engine executes one or more quality control rules to create a first compliance alert and/or a deadline record in the transaction database. The first compliance alert and/or the deadline record are promoted to a user via a user-specific user interface. A new compliance alert and/or deadline record is created or the first compliance alert and/or the deadline record is revised based on a response received from the user via the user interface. A periodic or on-demand automated report reflecting quality measures based on hospital performance is compiled and promoted according to one or more quality measures.

In a second interrelated aspect, a computer-implemented method includes receiving, at a rules engine implemented on one or more processors, patient data from one or more hospital business application servers; updating a transaction database stored on a storage device in communication with the one or more processors; executing, in the rules engine, a rule based on the patient data stored in transaction database; displaying content to a user via a user interface based on the executed rule; and updating the transaction database upon receipt of a response to the displayed content from the user.

Further optional and non-limiting variations can include one or more of the following features. The patient data received from the one or more hospital business application servers can be in a Health Level Seven (HL7) format and/or can include one or more of patient demographics and health condition information. The compliance alerts can include a notification to the specific patient to view educational media provided via a patient user interface accessible via a terminal in a patient room to which the specific patient is assigned. The notification can include a selectable link that provides the educational media to the patient user interface in response to selection by the specific patient of the selectable link. The one or more hospital business application servers can include one or more of a admit, discharge, transfer (ADT) database, a laboratory information system, a cardiology information system, and a decision support system. The updating can include ensuring that patient information in the patient information database is current and synchronized with hospital admissions, transfers, and discharges recorded in an ADT database of the one or more hospital business application servers.

The periodic or on-demand automated report can include a Joint Commission compliance report. The user interface can be a nurse console and the first compliance alert and/or the deadline record can be a request to a nurse user to verify if the specific patient has received an aspirin in accordance with post stroke or post-heart attack protocols established by the Joint Commission. The response received from the nurse user via the user interface can include a timestamp indicating when the aspirin was received by the specific patient. The user can be the specific patient and the first compliance alert and/or the deadline record can include linked video content viewable via the user interface. The specific patient can be a heart attack victim who smokes, the linked video content can be a smoking cessation video, and the response received from the user via the user interface can be an automated indicator that the specific patient has viewed the video.

The patient data received from the one or more hospital business application servers can be stored in a patient information database accessible to the rules engine and the transaction database can be updated after processing the patient data by the rules engine. The user can be a hospital staff member and the providing can include displaying the content to the user via a nurse console on a machine networked to the one or more processors. The content can include a patient-specific identifier and an alert or a compliance deadline for an action related to care of a patient designated by the patient-specific identifier.

The user can be a hospital staff member and the displaying content to the user can be performed via a wireless device. Access can be provided to a user for one or more of the following: shopping, entertainment educational information, and medical records, optionally via a user interface. The user can be a hospital staff member or a patient.

Articles are also described that comprise a tangibly embodied machine-readable medium operable to cause one or more machines, such as for example computers, processors, and the like, to result in operations as described above and in the detailed description below. Similarly, computer systems are also described that can include a processor and a memory coupled to the processor. The memory can include one or more programs that cause the processor to perform one or more of the operations as described above and in the detailed description below.

Implementations of the current subject matter can provide a number of possible advantages. For example, integration of disparate health care technologies into a user-friendly system that bridges the difficulties associated with such a disparate collection of technologies and subsystems is an important goal because of the opportunities such an integration presents for quickly and efficiently collecting and acting on patient data from a variety of sources including the patient himself or herself, reducing operation costs by easing administrative burdens on hospital employees and freeing staff from compliance-based patient education and counseling, creating patient service differentiators, maintaining patient contact and dialogue and extending patient care after discharge or between visits to the hospital, enhancing patient loyalty by enriching the in-patient experience through convenient and customizable media and communication access shopping, generating additional revenue streams by providing access to shopping as well as facilitating ordering and delivery of gifts for a patient from friends and relatives, and the like. For example, the current subject matter can help in building familiarity, loyalty, and long term links between a patient and a care facility such as a hospital, health clinic, nursing home, or the like. Frameworks consistent with the current subject matter can serve as a central system providing entertainment media, educational materials, communications, access to shopping, and the like. Systems and methods in accordance with the current subject matter can also assist in compliance reporting, for example with reports on patients as well as audits, medication and treatment logs, and like. Furthermore, the systems and methods of the current subject matter can be implemented using non-proprietary, proven technology without forcing the hospital to commit to a long-term, exclusive contract with a specific vendor.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram illustrating an example of an active patient management system;

FIG. 2 is a block diagram illustrating additional detail of an active patient management system;

FIG. 3 is a process flow diagram illustrating a method usable in an active patient management system;

FIG. 4 is a process flow diagram illustrating a further method usable in an active patient management system;

FIG. 5 is a screenshot of a patient user interface;

FIG. 6 is a screenshot of a nurse user interface;

FIG. 7 is a screenshot showing additional detail of a nurse user interface; and

FIG. 8 is a screenshot showing other additional detail of a nurse user interface.

When practical, similar reference numbers denote similar structures, features, or elements.

### DETAILED DESCRIPTION

The currently disclosed subject matter includes methods, systems, frameworks, articles of manufacture that provide a patient care environment usable in hospitals and other health care facilities or settings. For the purposes of this disclosure and the claims that follow, the term “hospital” will be used generically to describe any kind of healthcare setting such as a patient care or healthcare facility, including but not limited to hospitals, out patient or in patient clinics, doctor's offices, nursing homes, and the like.

An active patient management system consistent with the currently disclosed subject matter can include one or more of the following features: integrated access to a range of services; patient monitoring; quality of care monitoring and tracking; patient education; “virtual” shopping, such as for example access to goods and services via a web-based retail environment; entertainment, such as for example television, films, music, and the like; education; health education, such as for example patient education regarding a medical procedure, physical therapy, post-operative recovery, and the like; access to hospital medical staff; and access to medical records. Moreover, the active patient management system can, in some implementations, provide these features by actively accessing one or more systems existing at a hospital, such as an existing patient admittance system, databases, and the like. The current subject matter can also optionally provide an extensible framework that is adapted for a given, specific hospital. Secure access to an active patient management system from any location having Internet access can be optionally provided via one or more network interface. An active patient management system can also optionally track one or more metrics associated with quality of care. For example, hospital processes that are tracked by organizations, such as the Joint Commission on Accreditation of Healthcare Organizations (JCAHO or the “Joint Commission”), which rate and/or accredit hospitals based on their performance can be monitored, tracked, and/or improved using the current subject matter. In one example, tracking can include recording and reporting on whether patients are provided medication within time limits prescribed by the Joint Commission or whether patients are educated regarding an upcoming procedure as prescribed by the Joint Commission.

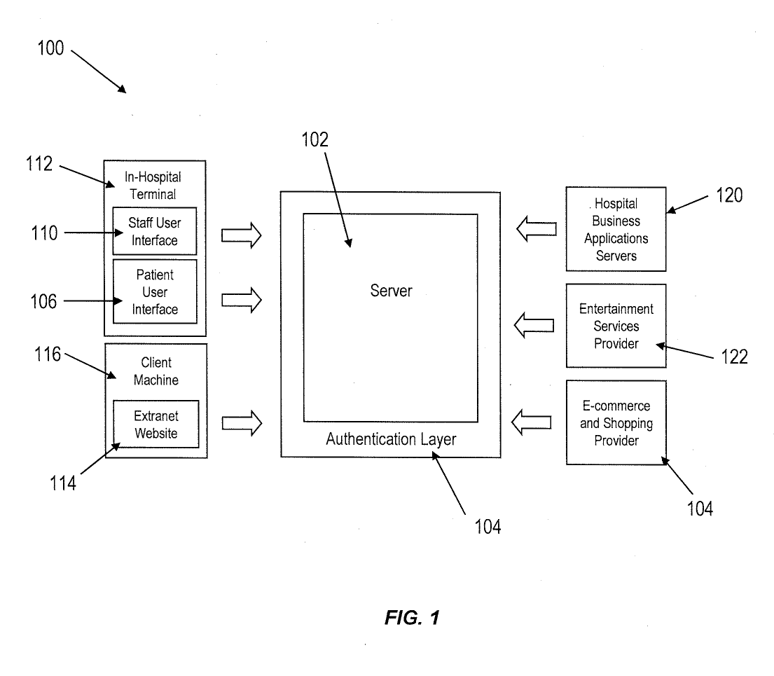

FIG. 1 shows a box diagram 100 depicting components of an active patient management system according to an implementation of the current subject matter. A server 102, which can be implemented on one or more processors can include an authentication layer 104 and can receive data inputs from a number of data sources and interfaces. The server 102 provides the core functionality of the active patient management system 100 and can operate as the mediator between users and providers of various services available to the users. The authentication layer 104 can be configured to provide data security and to ensure privacy of patient information. In some implementations, the server 102 does not store any patient-specific data that can be used to identify a patient. For example, a patient can be referred to by a unique patient identifier code that can in some examples denote the hospital building, wing, ward, and/or room number and, for a multi-patient room, the bed number. Thus, the patient's personal information can be securely retained on the hospital information system (HIS) tasked with managing the manage the administrative, financial and clinical aspects of the hospital.

By communicating with the HIS only using the unique patient identifier code, the security protocols of the HIS can be used to maintain patient privacy. HIS maintenance functions maintain data integrity between the hospital data and the server 102 and the authentication layer 104. The server 102 can use these functions to query the HIS and act upon them to manage data accessible by the server 102.

In some implementations, the authentication layer 104 can exchange confidential patient information with the HIS that can include the patient's personal information such as name, medical history, billing information, and insurance details; the patient's service data including, for example, one or more of billing rules and policies that are to be validated for the patient or other user, transaction details, credit card information, and usage information of value added services by the patient or user; patient usage data, which can include communications (e.g. e-mail and/or internet) usage, usage patterns and trends, and preferences or patterns of the patient or users media usage (e.g. movie, gaming, television, etc. preferences); and hospital data pertaining to the patient, possible including but not limited to classified medical care data, information regarding hospital staff, and hospital transactional records. The server 102 and authentication layer 104 can include protocols to ensure that all shared patient data follows required regulations and security procedures and to create a security layer protecting all patient data that can be used to prevent unauthorized access.

While in the hospital, a patient or hospital staff can access authorized content via a patient user interface 106 or a staff user interface 110, respectively. The patient user interface 106 and the staff user interface 110 can each be provided via in-hospital terminals 110 networked to the server 102 via the authentication layer 104. Patients and hospital staff can access services provided by the active patient management system via an appropriate staff user interface 110. Staff user interfaces 110 can be hosted on standard office computers or on dedicated terminals. The patient user interface 106 can be accessed from a patient room via a terminal 110 that can in some implementations be a media center personal computer or a set top box (STB) that houses components necessary to provide one or more of the features described herein. These terminals 110 can also act as a medium through which the patient interacts with various aspects of the active patient management system as described in greater detail below. Each of these terminals 112 can be registered with the server 102 and authentication layer 104 with a unique ID. This unique ID can be associated with the patient ID. Once a patient associated with the terminal 112 logs in, he or she can remain logged in the for use of that terminal 112 until the terminal 112 is associated with a different patient ID, for example when the first patient checks out and a new patient occupies the same bed. The in-room terminals 112 can include color monitors that can display media, speakers, a processor, input devices like keyboards and mouse, a wired or wireless remote control, special devices used by hospitals called pillow speakers that provide audio output as well as remote control capabilities, and the like.

Access to the server 102 can also be provided to patient's who are not in the hospital via an extranet website 114 opened in a browser on a client machine 116. For example, a web portal 106 can be accessed remotely through a browser on a machine or client 110 connected to the Internet or over some other extranet connection to the authentication layer. A remote user can register on the portal 106 and be provided with a Login Id and Password for use in logging into the portal 106. Remote access to the server 102 can be obtained by logging into the website portal 106, which create a communication channel to the authentication layer 102 for user authorization. The user is then provided access to those services that are authorized according to the user's identification. The Login ID for a patient can be associated with the unique patient identification used when the patient is in the hospital.

Services that can be provided through the web portal 106 can include but are not limited to shopping and E-commerce, and post-discharge patient care. A shopping extranet can be integrated with the hospital's gift shop and/or any other 3rd party vendor. Using this site, visitors can be presented with opportunities to buy from an online catalog and also ship gifts to patients in the hospital. After discharge from the hospital, a patient can keep connected with the hospital to access hospital resources, such as for example educational media, as well as their patient care data. Extranet access can also be provided to vendors running the online shops, for example for hosting catalog based shops and receiving notification of order fulfillment and order delivery. Catalog services can allow a vendor to upload/manage the catalog they want to be displayed in the shopping site. Once an order is placed in the online store, the order can be forwarded to a fulfillment service as defined by the vendor. A payment gateway interface can be provided through the extranet to allow vendors to easily integrate with third party payment gateways such as PayPal, Shift4, and other credit card or electronic payment processing vendors. A vendor can be granted access to these extranet services which can optionally be accessed through the web portal 106.

The server 102 can also communicate with one or more hospital business applications servers 120 that are used by the hospital for maintaining patient information as well as other data and for administering various tasks. The data stored on these hospital business applications servers 120 can include, but is not limited to patient information data; patient medical history data; information regarding hospitals, hospital staff, doctors, nurses, and the like; and other business applications. Data security and authentication can be handled by the authentication layer 104.

An entertainment services provider server or servers 122 can also be in communication with the server 102, optionally via the authentication layer 104. The entertainment services provider server or servers 122 can provide content for entertainment of patients or other users, optionally on pay-per-view or pay-per-use basis. The entertainment content services providers can include, but is not limited to television services providers, movie services providers, music service providers, internet content services providers, and the like. Access to the entertainment services provider server or servers 122 can be facilitated through a media gateway application that redirects the media content available from the entertainment service provider servers 122 to the patient user interface 106 of a user or patient who wishes to access that content. The media gateway can check for required licenses and/or billing data before allowing the patient or user to view the requested content. The server 102 can also include a content management module that manages all the content available for access by patients or users via the patient user interface 106. Once a patient or user requests for any content, the content management module can check for the user's permission to access the requested content. Only an authorized user is allowed to consume the content.

E-Commerce or shopping services providers 124 can also be in communication with the server 102, optionally via the authentication layer 104. The E-Commerce or shopping services providers 124 can provide service that a patient or other user can use to buy merchandise from one or more retail outlets. Payment can be processed through a payment gateway. Services provided by the shopping E-Commerce or shopping services providers 124 can include, but are not limited to catalogue shopping, a payment gateway or processor, information regarding buyers and sellers, and the like.

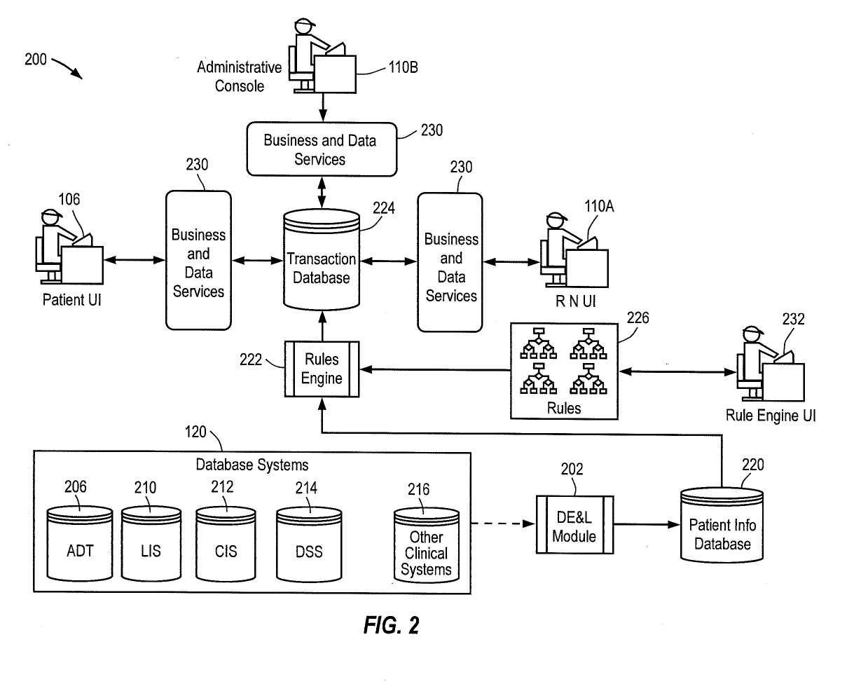

FIG. 2 shows a box diagram of a system 200 for actively managing patient data and care processes according to an implementation of the current subject matter. A data extraction and load module 202 receives data from one or more hospital business applications or database systems 120, possibly including but not limited to a hospital admit/discharge/transfer (ADT) system 206 that is responsible for centralizing admissions, discharges and/or transfers in a hospital; a laboratory information system (LIS) 210, a cardiology information system (CIS) 212, such as for example the MUSE electrocardiograph system (available from GE Healthcare), a decision support system (DSS) and 214; and/or other clinical systems 216. The data extraction and load module 202, which can be implemented on the server 102, further loads the information received from the one or more hospital business applications or database systems 120 into a patient information database 220 stored on one or more memories or other storage devices accessible by the server 102 either directly or over a network. The information received from the one or more hospital business applications or database systems 120 can be in the Health Level Seven (HL7) format and can contain patients' demographics, health condition, and the like. The HL7 format is a messaging standard designed to ensure that incongruent healthcare software applications are able to exchange primary administrative and clinical data.

For each new message loaded by the data extraction and load module 202 into the patient information database 220, a rules engine 222 creates a record in a transaction database 224 also stored on the one or more memories or other storage devices accessible by the server 102 either directly or over a network. The rules engine 222 can also be implemented on the server 102. For example, when a patient is discharged from the hospital, an associated record is created by the ADT system 206, the bed can be automatically marked empty in the transaction database 224. Other types of information that can be automatically updated in the transaction database 224 include but are not limited to a patient's medical record number (MRN), which is a unique identifier assigned by the hospital and which can be retrieved from the patient identification (PID) segment of an ADT message received from the ADT system 206 by the data extraction and loading module 202 and stored in the patient information database 220; a visit number, which is a unique number identifying the patient's latest encounter with the hospital and which is automatically assigned by the ADT system; an event from the EVN segment in the message from the ADT system distinguishing if the patient is admitted, discharged or transferred; an admission timestamp that can include the data and time the patient was admitted to the hospital; a unit and bed number denoting where in the hospital the patient is located (for example, Nursing unit A, bed A2); a disease category, which can be mapped from an International Statistical Classification of Diseases and Related Health Problems (ICD9) code (for example an ICD9 code of 410.60 maps to the disease category of “acute myocardial infarction or heart attack); the patient's age at the time of the admission; and a flag indicating the patient's smoking habits.

The rules engine 222 includes a rules library 226 that can be stored on the one or more memories or other storage devices accessible by the server 102 either directly of over a network. Rules stored in the rules library 226 can be applied contextually to data received at the patient information database 220. For example, the rules can be used to determine the meaning of the data received at the patient information database 220; to determine what one or more data messages mean; to add context to the data; to insert alerts and/or notifications for nurses, doctors, or patients; to show alerts or notifications on one or more user interfaces targeted to nurses, doctors, or patients; or showing instructional videos to selected patients, doctors, or nurses that meet certain criteria (for example, cardiac patients who smoke may be shown an educational video). The rules engine 222 can also include rules that associate the members of a primary care team, for example interns, residents, attending physician, primary nurse and nurse backups, to the patient at the unit and bed number indicated on the transaction database 224. A rule engine user interface 232 can also be included in the active patient management system to allow creation and/or modification of specific rules that can be made available for execution by the rules engine. In some implementations, the rule user interface 232 can be made accessible only to a vendor of the active patient management system or to a select group of consultants or other people who specialize in designing rules that execute required tasks according to regulatory or compliance-based measures. Rules that are created or modified according to this procedure can be made available for use by the rule engine 222 via the rules library 226. A given hospital can choose from the rules available in the rules library 226 which rules are to be executed by the rule engine 222.

The transaction database 224 provides backend support, for example through one or more business and data services modules 230 for one or more user interfaces, for example the patient interface 106 and one or more staff interfaces 110 that can include a nurse console 110A and an administrative console 110B. The nurse console 110A provides access to the transaction database 222 and can be configured to allow a nurse or other personnel with comparable access privileges to perform, record, schedule or the like one or more patient care, recording-keeping, administrative, and other tasks such as allocating additional doctors as specialists or consultants to the patient. For example, if the patient has diabetes, the nurse can assign a specialist from the diabetic center and the referring doctor to the patient. A specific patient can be shown names and profiles of the members of the primary care team and the specialists or consultants on the user interface 106 displayed on the in-room terminal 110.

The rules engine 222 can in some implementations operate as follows to actively monitor, track, and/or manage patient care. If applicable, the rules engine 222 can use a disease category received from one or more of the hospital business applications or database systems 120 for a patient with a given disease to assign any educational videos associated with that disease. For example, if a record is stored in the transaction database indicating admittance of a patient suffering form an acute myocardial infarction (AMI, also know as a heart attack), an educational video relating to AMI can be delivered to the patient user interface for that patient. Non-limiting examples of possible educational videos include those explaining the patient's medical condition, ailment, status, etc (e.g. a heart attack); available treatment options as well as risks and pros/cons of each option; the medical effects of smoking; details of a particular treatment option (e.g. an angioplasty procedure), and the like.

The administrative console 110B can be accessed by an administrator, a nurse, or a doctor in a hospital to perform various additional custom tasks. For example, a user at the administrative console 110B can add additional videos to be viewed by a patient according to specific procedures that the patient is to consider. An angioplasty video could be made available if that procedure is a treatment option. The administrator console 110B can be used to configure the behavior of the active patient management system instance at the hospital. The administrator console 110B can be also used to manage the educational material and clinician's profile shown to the patients.

The rules engine 222 can access applicable quality measures for a given patient based on the rules published by the Joint Commission and the Center for Medicare & Medicaid Services (CMS). For example, the rules engine 222 can check for the medical record to verify if the patient has received an aspirin in accordance with post stroke or post-heart attack protocols established by the Joint Commission and also note the timestamp for the drug administration. If the hospital business applications or database systems 120 of the hospital do not have any record of a required drug administration, the rules engine 222 can insert an alert record to monitor status of aspirin on arrival within 24 hrs or before arrival at the hospital as required by AMI-1 quality measure. Any deadlines can be marked based on the admission timestamp with a target window for completion (e.g. +24 hours from admission for aspirin administration). The rules engine 222 can insert an alert record to monitor status of one or more patient education or counseling sessions, for example a video regarding adult smoking cessation advice or counseling, which is required by the Joint Commission as a quality measure for heart attack patients.

For each patient, the rules engine 222 can process any necessary alerts, notifications, or the like. For example, if there is no record of a heart attack patient receiving aspirin in the hospital systems, the rules engine 222 can display a query to the patient via the patient user interface 106 that asks the patient to indicate whether they have received aspirin and if so, when. Patient responses to questions generated by the rules engine 222 and presented in the patient user interface 232 can be used to update the transaction database 224 which in turn can cause one or more alert messages to be displayed on the nurse console 110A to change. For example, if the patient replies affirmatively in response to a question presented in the patient user interface 106 regarding administration of aspirin, the rules engine 222 can update a corresponding alert message displayed on the nurse console 110A to indicate that the particular patient in the assigned bed believes that he/she has received aspirin within the last 24 hrs even though no record is present in the hospital business applications or database systems 120. The nurse console 110A can further query a nurse user whether he or she wishes to update the medical records for the aspirin administration. Similarly, if for example a patient does not view a required video such as the smoking cessation video, an alert can be shown via the nurse console 110A. If a nurse or other authorized user accessing the system 100 via the nurse console 110A chooses to update the record, the rules engine 222 can update medical records for the specific patient with medication details and also update the audit information in the transaction database 224 and/or the patient information database.

The rules engine 222 can also scan clinical information from the hospital business applications or database systems 120 to compile a Joint Commission compliance report and submit data electronically. Based on the data from the hospital business applications or database systems 120, the rules engine 222 can also create a drill down management report summarizing compliance of the hospital to one or more externally established quality measures.

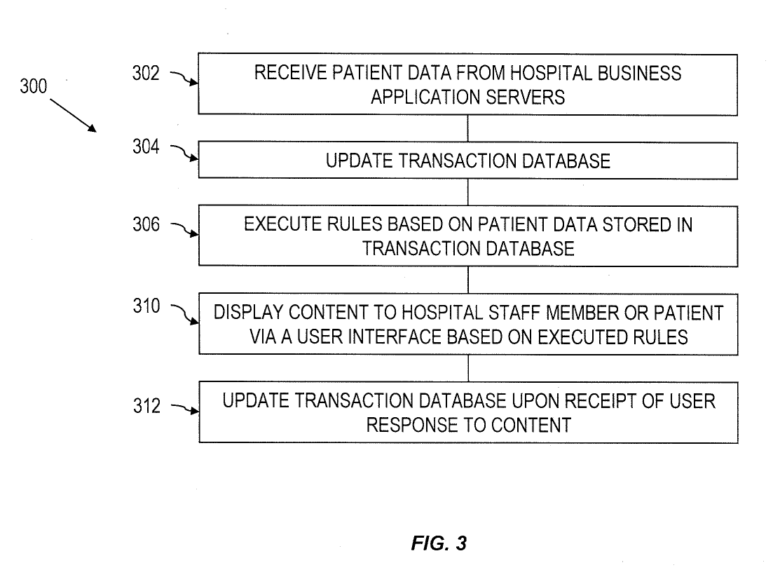

FIG. 3 shows a process flow chart 300 that illustrates various features of an active patient management method according to an implementation of the current subject matter. At 302, a server 102 receives a patient datum from one or more hospital business application servers 120. At 304, a rules engine 222 implemented on the server 102 updates a transaction database 224 that is stored on a memory or a storage device accessible by the server 102. The updating of the transaction database reflects any changes to contextual data about care of the patient that is stored in the transaction database based on the received patient datum. At 306, the rules engine 222 executes one or more rules based on the patient data stored in the transaction database. At 304 the rules engine 222 can query the database 220 to execute various business and data services 230 and update the transaction database 224. At 306, the rules engine 222 can query the transaction database 224 through the business and data services 230 to display an alert or message on patient user interface 106 or the nurse console 110A. The rules can cause content to be displayed to a hospital staff member or a patient via a user interface 106, 110A, or 110B at 310. The displayed content can include one or more of a query, an alert, or media content. Upon receipt of a user response at 312 via the user interface 106, 110A, or 110B, data in the transaction database 224 is updated accordingly.

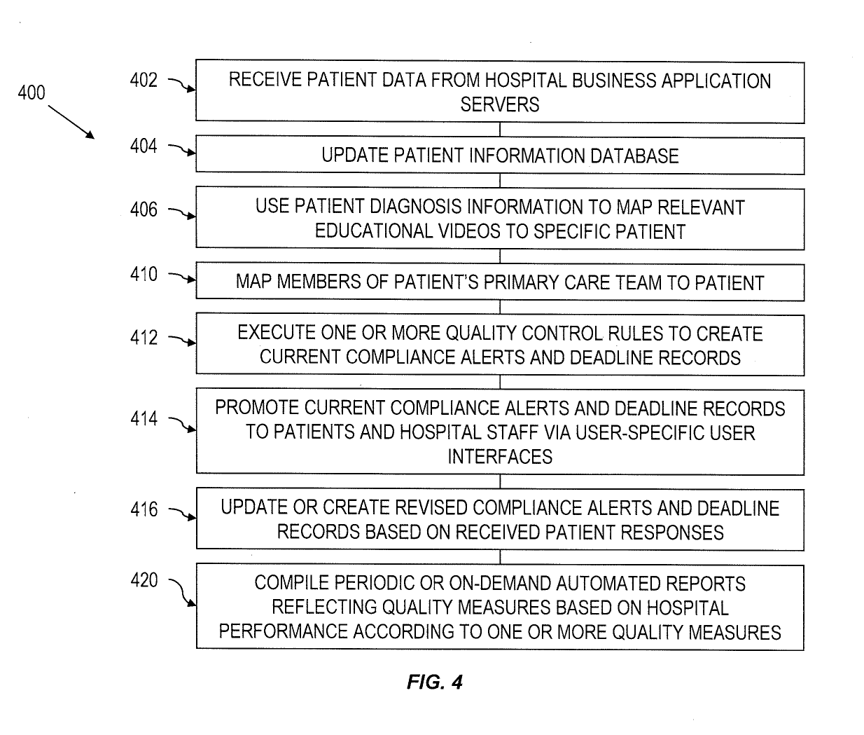

FIG. 4 shows a process flow chart 300 that illustrates additional various features of an active patient management method according to an implementation of the current subject matter. At 402, a data extraction and load module 202 hosted on one or more servers 102 receives patient data from one or more hospital business application servers 120 that can optionally include ADT, LIS, CIS, DSS, and other clinical system databases. At 404, a rules engine 222 implemented or hosted on the one or more servers 102 updates a patient information database 220 stored on one or more memories or storage devices accessible by the server 102. This updating can include ensuring that patient information in the patient information database 220 is current and synchronized with hospital admissions, transfers, and discharges recorded in the ADT system. At 406, the rules engine 222 uses patient diagnosis information to map any relevant educational videos to a specific patient based on a unique patient identification number or code. The rules engine 222 also at 410 maps members of the patient's primary care team to the patient based on a unique patient identification number or code. At 412, the rules engine 222 executes one or more quality control rules to create new compliance alerts and deadline records for the specific patient and update existing compliance alerts and deadline records. The current set of compliance alerts and deadline records is promoted to patients and hospital staff via user-specific user interfaces at 414. The patient user interface 106 can prompt a patient for tasks such as medication status, scheduled therapies, counseling, etc. The nurse console 110A can display unit level alerts and deadlines for all patients in a hospital unit, floor, ward, etc.

After the rules engine 222 receives responses from patients and hospital staff to the promoted current compliance alerts and records, the rules engine 222 at 416 executes the one or more quality control rules to revise the compliance alerts and deadline records based on the received responses. The rules engine 222 at 420 can also compile periodic or on-demand automated reports reflecting quality measures based on hospital performance according to one or more quality measures. Data from the transaction database 224 is used to create these reports.

Hardware installed in patient rooms for implementations of the current subject matter can include a terminal 106 that can be accessible by support personnel and patients. The terminal 106 can be a computer terminal such as a personal computer or can optionally include a less fully-functional terminal that displays an interface to a process executed on a central server, including but not limited to the server 102. The in-room equipment can also include a display monitor whose size and resolution can depend on the location and distance from the patient. In some implementations, a 30″ monitor (or bigger) can be provided with 1024×768 pixel resolution and a VGA or HDMI video input. A remote control can be provided that includes infrared and/or radio frequency communication with the terminal 106. The remote control can provide convenient media operation and navigation, and can optionally include input features such as pointing and selecting user interface features displayed on the screen. The remote is advantageously medically certified to avoid interference with treatment critical equipment in the hospital. One or more speakers can be included to provide audio to accompany on-screen content. In some implementations, the speakers can be part of a wired or wireless device such as a “pillow speaker” that provides control of the operations of the terminal and includes one or more small audio speakers and/or a nurse call button. Headphones with an accompanying headphone jack can also be provided.

A dock, USB outlet, or wireless interface can be provided to enable the patient to connect a personal media-capable device to the in-room system components on a view only level without allowing syncing or other access to networked resources. Such devices can include, but are not limited to, an MP3 player like an iPod, a media player like an iTouch, or other portable communication and media devices (e.g. iPhone, mobile wireless device, PDA, and the like) as well as wireless devices, such as personal digital assistant (e.g., an iPod) that can display personal photographs, music, audio books, television programs, movies, podcasts etc. Viewing or listening to the patient's personal media can be enabled via the in-room display and/or the speakers. This feature enables patients to bring the entertainment comforts from home into the hospital and view their media transparently on the larger room television.

One or more features, such as for example slide shows or single images; audible content such as music, audio books, poetry, etc.; video content such as movies, television programming, cartoons, on demand video, etc.; internet or World Wide Web access; communications services such as e-mail, SMS or MMS messaging, telephone, etc.; health care waiver acceptance or refusal prompts; access to electronic health records (EHR) and security protocols for such records; other administrative tasks and content; shopping access for goods and/or services; educational content regarding health issues, procedures, preventative treatments, aspects of post-procedure recovery, etc.; access to various remote functions; and access to relevant information about medical and/or care-provider staff can be provided to a patient via the patient user interface 106. Visual features can be provided via a patient user interface displayed on a terminal in the patient's room, via a television or other display screen, on a wireless or wired communication device, or the like. Audible content or features can be provided via speakers, either fixed in a patient room, attached to or otherwise part of a mobile device, or the like, through earphones, or the like.

A patient user interface 106 according to an implementation of the current subject matter can be accessible via the terminal 106 in a patient room that can optionally have a remote control or other user input device, such as for example a keyboard, a mouse, a touch-sensitive trackpad or scroll wheel, a wired or wireless pointer device, via which a user can select a screen region. Alternatively, the patient user interface can be implemented on a portable device, such as for example a laptop computer, a touch screen tablet, a combination of one or more of such devices, or the like. Content can be displayed on an in-room screen such as a cathode ray tube or flat panel television or computer monitor or screen. The patient user interface can include one or more modules via which information can be presented to the patient in response to received inputs.

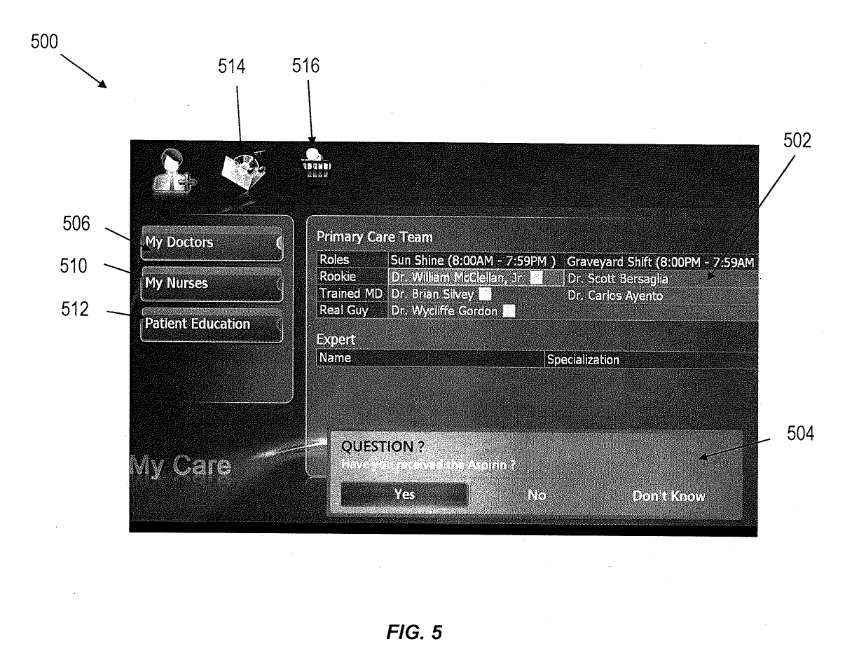

A care details module displayed within the patient user interface 106 can include access to information about doctors and nurses assigned to the patient and can also provide educational content. A doctor information screen can list doctors in the patient's care team. The list of doctor names can be in a grid format 502 such as is shown in the screen shot 500 in FIG. 5 to indicate additional information about each doctor, such as the doctors who are on duty for each shift or time period, a doctor's area of specialization and level, for example intern, resident, chief resident, attending doctor, consultant, specialist, or the like. Clicking on a doctor's name can activate a link provided to a doctor's profile that can include more detailed information, such as an education history, biographical information, certifications, results of patient satisfaction surveys, and the like. The doctor information screen can also include links to a nurse information screen, an educational content screen, and/or other screen accessible by the patient.

FIG. 5 also shows and example of a prompt 504 promoted to a patient via the patient user interface 106. Also shown in FIG. 5 are selectable icons linking to a doctor information screen 506, a nurse information screen 510, and a patient education screen 512 as well as additional selectable icons linking to a media module 514 and a shopping module 516.

The nurse information screen can list the primary nurses on a patient's care team. Both primary nurses and “care partners” can be listed. As with the doctor information screen, the applicable nurses can be listed in a grid format that shows the shifts during which each nurse is on duty. Links can be provided to a nurse's profile that can include more detailed information, such as an education history, biographical information, certifications, results of patient satisfaction surveys, and the like. The nurse information screen can also include links to the doctor information screen, the educational content screen, and/or other screen accessible by the patient.

The educational content screen can list educational content assigned to the patient. The educational content can include video, graphical, and/or audio content that explains one or more aspects of patient care, preventative or therapeutic strategies or techniques, a procedure to be performed, recovery from a procedure, exercises, general health knowledge, and the like. The listing of available or assigned educational content can indicate visually, for example by a color of the link, whether the patient has already viewed or otherwise experience that educational content. Alternatively, the available or assigned content can be listed in a grid format. The grid can include a “title” field, a “description” field, and a “status” field. A patient can commence reviewing of an educational content item by clicking or otherwise selecting the title, the description, or some other user interface element. Some educational content items can be associated with a risk acknowledgement or some other type of waiver feature that the patient is required to execute to indicate that he or she has reviewed and understood the necessary material and agreed to accept any detailed risks of an upcoming procedure or other medical treatment option. The status field can optionally include a status indicator, such as for example text indicating whether the educational content is newly added, in-progress (indicating for example that the patient has viewed the content but has not executed a required waiver), or completed (indicating for example that the patient has viewed the content and executed the required waiver). Upon selecting a link to educational content that includes a required execution of a waiver, the patient can be shown a risk acknowledgment screen either prior to or after displaying of the selected educational content. The educational content screen can also include links to the doctor information screen, the nurse information screen, and/or other screen accessible by the patient. The patient user interface 106 can also remind the patient to watch a video prescribed by the physicians, specially if the patient is scheduled for a procedure and present forms for electronic consent or signatures at the end of the educational video.

The patient user interface 106 can also provide access to a media module that can provide entertainment content, communications access, or the like to a patient. The media module can include selectable screen for video entertainment (for example television, on-demand movies, or the like), audio entertainment (for example music, books on tape, or the like), gaming content, internet access, video conferencing, e-mail, telephone, etc. Video and television content can be searchable and/or sortable by a number of characteristics, such as title, actor, genre, era, or the like. Similarly, audio content can be searchable and/or sortable by characteristics that could include song or album title, artist name, genre, era, etc. The media module can also include payment processing screens that are displayed upon selection of certain non-complimentary content and that inform the patient of the costs for certain media content and also provide payment options (for example, payments by credit card, debit card, deferred billing in a single statement upon patient checkout, or the like). An on-screen option can also be provided during playback of certain entertainment content that allows the patient to purchase a copy of the entertainment content via an online reseller, for example on a physical medium such as a compact disk or DVD or by download to a personal media device such as a computer, MP3 player, portable or console game system, personal communication device, or the like. In this manner the patient user interface can provide several potential revenue streams for a hospital while also improving the patient experience by providing access to a much richer selection of customizable and user-selectable entertainment options than are typically available in current hospitals.

The patient user interface 106 can also provide access to a shopping module that allows patients to access a virtual shopping portal. Screens can be shown to display a patient's order history, suggestions for items the patient might wish to purchase based on prior purchases and searches or based on entertainment content experienced through the media module, order status, and the like. The patient can be presented with a number of search options. For example, a shopping welcome screen can include links to shopping categories, such as for example books, educational material, toiletries, clothing, music, entertainment, and the like. The shopping module can also include payment processing screens that are displayed upon selection of a “checkout” or instant purchase option. The payment processing screen or screen can provide payment options (for example, payments by credit card, debit card, deferred billing in a single statement upon patient checkout, or the like) and provide a confirmation link for the patient to complete a purchase. Options can be provided for delivery of physical goods either to the patient's room or to other locations (home, office, hospital main desk, etc.).

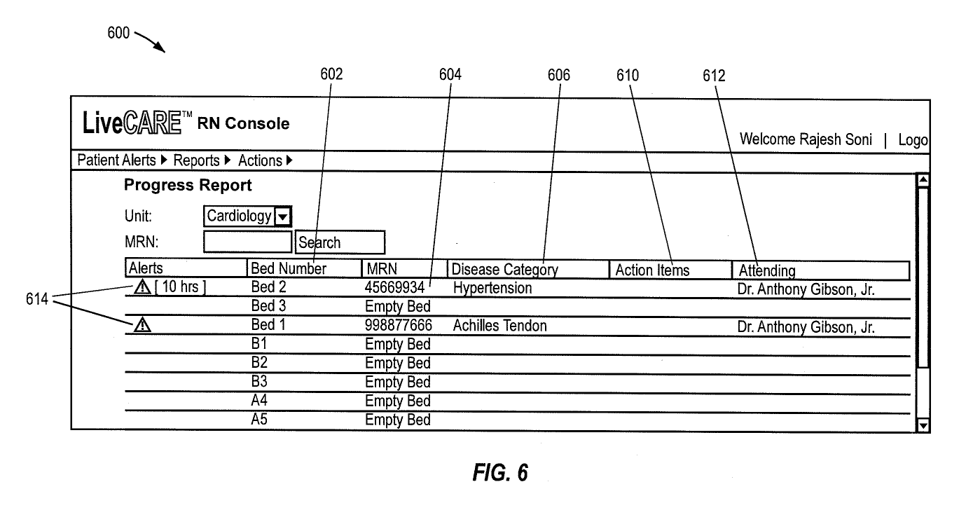

FIG. 6 depicts a screen shot 600 of a nurse console 110A provided for access, for example, by a registered nurse (RN) on the hospital staff. The nurse console 110A can be designed for use by both doctors and nurses. A console unit level view as shown in FIG. 6 can give a snapshot of the entire unit to administrative nurses summarizing several things with the help of icons and images. One or more of the following may be provided to the user interface for presentation: number of beds in the unit that are occupied or empty, bed level reminders (alerts) prompting the nurses to take an action on something, and deadlines and time remaining for any reminders. A nurse console 110A user can sort the information on any column in ascending or descending order. By default the unit can be sorted on the deadline in descending order (closest deadline on the top). A nurse console 110A user can also do a quick search for a given patient using the patient's medical record number or other identifier to see patient-specific details without having to scroll through the list of beds in the unit. Each bed in a unit can be listed according to a bed identifier 602 such as a bed number. The patient in a given bed can be identified by a patient identifier 604. Another column or area of the nurse console 110A can include information on the disease or health condition affecting the patient and can be listed according to a disease category 606. Action items 610 and information or links to information about the patient's health team, for example the patient's attending physician 612 can also be shown. If an action is required for a patient, an alert icon, for example a timer showing the countdown to a deadline established based on a rule executed by the rule engine 222 can be displayed. If there are multiple alerts, the closest deadline can be shown next to the bed.

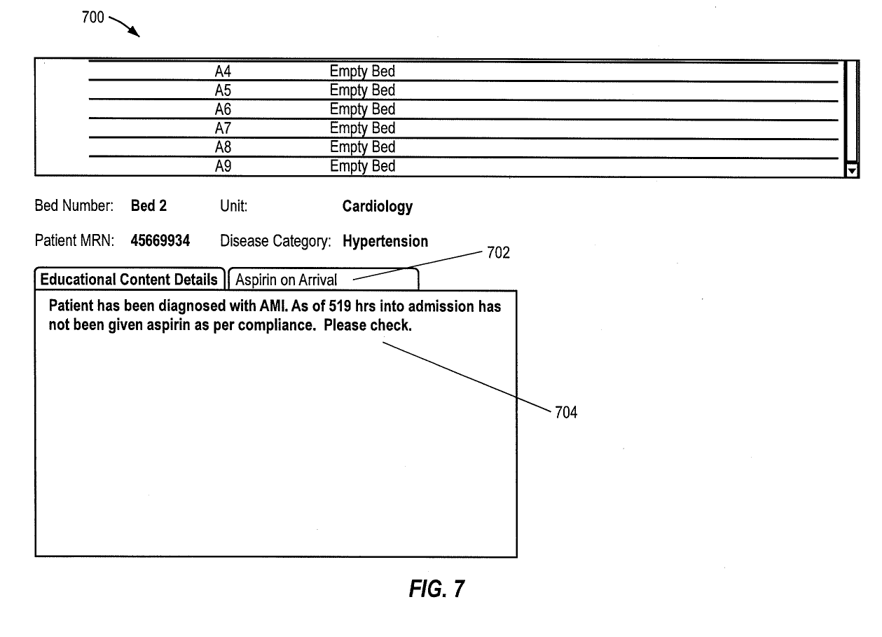

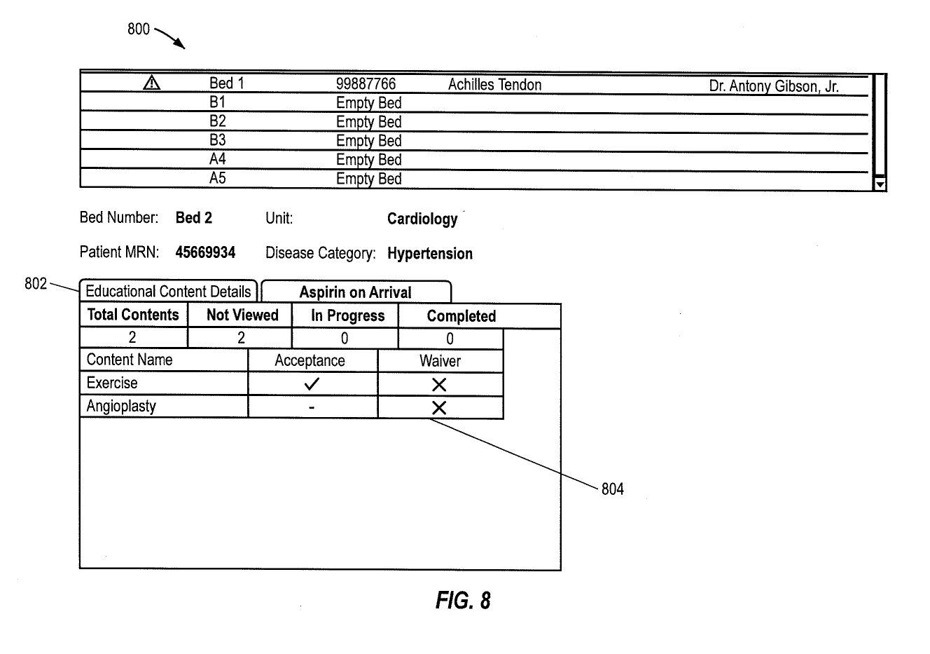

When a nurse console 110A user clicks on any bed, the screen can show patient details and associated reminders while keeping the unit level summary on the top as shown in the screenshots 700 and 800 shown in FIG. 7 and FIG. 8, respectively. Each alert (e.g., a reminder) can be generated through the rules engine 222 and can be completely modular (e.g., independent of other alerts). A hospital can customize the active patient management system 100 by selecting which modules to implement. Upon selection of the “aspirin on arrival” tab 702, for example, the user interface shows information 704 that indicates whether the required action has been completed. Upon selection of an “education content details” link 802, the user interface can display, for example, a grid 804 listing educational videos assigned to the patient, along with status (viewed/not viewed) and whether the patient has accepted the disclaimers and marked digital signatures for receiving counseling.). The nurse console 110A can be implemented as a component that can be embedded in an existing hospital systems supporting service oriented architecture (SOA) (e.g., as a component of a nurse call stations supporting a rounding list, a hospitals' paging system or emergency department system).

One or more features, such as for example EHR access, download or synchronization; HIPAA compliance; remote functions; imagery of text results and the like, such as for example X-Ray, MRIs, CAT-scans, etc.; and access to communication interfaces such as e-mail, SMS or MMS messaging, telephone, etc., can be provided to a health care provider, such as for example a nurse, doctor, administrator, or the like via either the nurse console 110A or the administrator console 110B. In one implementation, a personal communication device can be integrated into the active patient management system 100 to provide a portable administrator or nurse console 110A or 110B that enables a doctor or other hospital staff to access features of the system 100 without being tied to a computer terminal. In one example, Apple Computers 2.0 software for iPhone can be used to enable such integration. The portable communication device can include a portal that provides secured access to records and features for which the device owner has authorized access. A doctor or other hospital staff can retrieve electronic health records (EHR) and other content via syncing with the active patient management system 100 to access information in the transaction database 224 and the patient information database 220. Physicians can leave physical media such as x-ray films and medical charts behind and utilize the iPhone or other portable personal communication device as their computer and display information on the patient's television via docking the iPhone/iPod/PDA. Wireless devices can also be used for regulatory compliance by enabling acceptance of HIPAA waivers via email on their device (e.g., an iPhone, wireless device, laptop computer, and the like), furthering transparent integration between patient care, medical information and healthcare systems. As an alternative, the physicians could use the administrative console 110B to associate specific clinical charts, x-rays, and the like with a patient and use the patient user interface 106 on the patient terminal 110 to display the clinical information to the patient after authenticating.

The subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, webservices, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input.

The subject matter described herein can be implemented in a computing system that includes a back-end component, such as for example a data server, or that includes a middleware component, such as for example an application server, or that includes a front-end component, such as for example a client computer having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. Other implementations may be within the scope of the following claims.

What is claimed:

1. A computer-readable medium containing instructions to cause one or more processors to perform operations comprising:
updating a patient information database accessible to a rules engine that is implemented on the one or more processors, the updating occurring upon receipt of patient data from one or more hospital business application servers;
mapping a relevant educational video to a specific patient and members of the specific patient's primary care team to the specific patient based on the received patient data, the mapping being performed by the rules engine and being stored in a transaction database accessible to the rules engine;
executing one or more quality control rules by the rules engine to create a first compliance alert and/or a deadline record in the transaction database;
promoting the first compliance alert and/or the deadline record to a user via a user-specific user interface;
creating a new compliance alert and/or deadline record or revising the first compliance alert and/or the deadline record based on a response received from the user via the user interface; and
compiling and promoting a periodic or on-demand automated report reflecting quality measures based on hospital performance according to one or more quality measures.

2. A computer-readable medium as in claim 1, wherein the patient data received from the one or more hospital business application servers is in a Health Level Seven (HL7) format.

3. A computer-readable medium as in claim 1, wherein the patient data received from the one or more hospital business application servers comprises one or more of patient demographics and health condition information.

4. A computer-readable medium as in claim 1, wherein the compliance alerts comprise a notification to the specific patient to view educational media provided via a patient user interface accessible via a terminal in a patient room to which the specific patient is assigned, the notification comprising a selectable link that provides the educational media to the patient user interface in response to selection by the specific patient of the selectable link.

5. A computer-readable medium as in claim 1, wherein the one or more hospital business application servers comprise one or more of a admit/discharge/transfer database, a laboratory information system, a cardiology information system, and a decision support system.

6. A computer-readable medium as in claim 1, wherein the updating comprises ensuring that patient information in the patient information database is current and synchronized with hospital admissions, transfers, and discharges recorded in a admit/discharge/transfer database of the one or more hospital business application servers.

7. A computer-readable medium as in claim 1, wherein the periodic or on-demand automated report comprises a Joint Commission compliance report.

8. A computer-readable medium as in claim 1, wherein the user interface is a nurse console and the first compliance alert and/or the deadline record is a request to a nurse user to verify if the specific patient has received an aspirin in accordance with post stroke or post-heart attack protocols established by the Joint Commission.

9. A computer-readable medium as in claim 9, wherein the response received from the nurse user via the user interface comprises a timestamp indicating when the aspirin was received by the specific patient.

10. A computer-readable medium as in claim 1, wherein the user is the specific patient and the first compliance alert and/or the deadline record comprises linked video content viewable via the user interface.

11. A computer-readable medium as in claim 11, wherein the specific patient is a heart attack victim who smokes; the linked video content is a smoking cessation video; and wherein the response received from the user via the user interface is an automated indicator that the specific patient has viewed the video.

12. A computer-implemented method comprising:
receiving, at a rules engine implemented on one or more processors, patient data from one or more hospital business application servers;
updating a transaction database stored on a storage device in communication with the one or more processors;
executing, in the rules engine, a rule based on the patient data stored in transaction database;
promoting content to a user via a user interface based on the executed rule; and
updating the transaction database upon receipt of a response to the promoted content from the user.

13. The method of claim 13, further comprising:
storing, in a patient information database accessible to the rules engine, the patient data received from the one or more hospital business application servers; and
updating the transaction database after processing the patient data by the rules engine.

14. The method of claim 13, wherein the user is a hospital staff member and the providing further comprises displaying the content to the user via a nurse console on a machine networked to the one or more processors; the content comprising a patient-specific identifier and an alert or a compliance deadline for an action related to care of a patient designated by the patient-specific identifier.

15. The method of claim 13, wherein the user is a hospital staff member and the displaying content to the user who is performed via a wireless device.

16. The method of claim 13, further comprising providing access to a user to one or more of the following: shopping, entertainment educational information, and medical records.

17. The method of claim 13, wherein the user is a hospital staff member or a patient.

18. An active patient management system comprising:
one or more processors that perform operations comprising:
updating a patient information database accessible to a rules engine, the updating occurring upon receipt of patient data from one or more hospital business application servers;
mapping a relevant educational video to a specific patient and members of the specific patient's primary care team to the specific patient based on the received patient data, the mapping being stored in a transaction database accessible to the rules engine;
executing one or more quality control rules by the rules engine to create a first compliance alert and/or a deadline record in the transaction database;
promoting the first compliance alert and/or the deadline record to a user via a user-specific user interface;
creating a new compliance alert and/or deadline record or revising the first compliance alert and/or the deadline record based on a response received from the user via the user interface; and
compiling and promoting a periodic or on-demand automated report reflecting quality measures based on hospital performance according to one or more quality measures.
